(19) United States
(12) Patent Application Publication
(10) Pub. No.: US 2009/0035412 A1
(43) Pub. Date: Feb. 5, 2009

(54) HYBRID LAY-UP TOOL

(76) Inventor: Thomas J. Sobcinski, Coon Rapids, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/831,767

(22) Filed: Jul. 31, 2007

(51) Int. Cl. B29C 43/36; B23K 1/00

(52) U.S. Cl. 425/389; 164/230; 264/219

(57) ABSTRACT

The present invention relates to a hybrid lay-up tool comprising a thin metallic working surface and a composite back structure. The working surface may be an Invar working surface, and the working surface and the back structure may be coupled using a self-locking connection mechanism. The present invention also relates to a method for providing a hybrid lay-up tool. The method may include providing a metallic face sheet, providing a composite back structure, and operably coupling the metallic face sheet with the composite back structure using a self-locking connection mechanism.

### FIELD OF THE INVENTION

The present disclosure relates to apparatus and methods for lay-up tools. More particularly, the present disclosure relates to apparatus and methods for lay-up tools comprising a hybrid combination of Invar and composite construction.

### BACKGROUND OF THE INVENTION

Current lay-up tool technologies utilize either all-Invar or all-composite construction. An all-Invar or all-composite construction is the currently preferred construction of tools for large, graphite fiber based parts due to the match in coefficient of thermal expansion to the composite part being produced. These tools may be subjected to a range of temperatures and pressures; common temperatures are around 350° Fahrenheit, and pressures commonly are around 100 PSI.

Large Invar tools have been considered the industry standard for lay-up tools used to manufacture large advanced composite parts for the past 20 years or more. All-Invar tools are very heavy. In some cases, all-Invar tools may exceed 200,000 pounds. Thus, the weight of Invar tools can be prohibitive.

Composite tools have been used for short run parts or large parts where the weight of Invar becomes prohibitive. The cost of ownership of an all-composite tool can be high due to shorter tool life, cost of a master for laying up the composite tool, material costs incurred for replacement tools, machining hours incurred for replacement tools, cost of tool repair during production, and cost of lost production due to tool repairs. Tool repair during production may be necessary since all-composite tools are not as durable as metallic tools and required periodic repairs during the lifetime of the tool. Therefore, the durability and stability of all-composite tools is questionable.

Composite tools, furthermore, have a shorter life span than Invar tools. For example, as temperatures during lay up elevate to near the temperature of molding for the composite tool, the tool may be degraded over time and use. Additionally, few traditional tooling suppliers are willing to machine faces of composite tools. Thus, supplier capability and capacity for making large composite tools is a problem.

In addition to the traditional problems for each type of tool discussed above, there remains a lack of proven methods for rework of the tools.

There is a need in the art for apparatus and methods for lay-up tools without the complications presented by prior lay-up tools. There is a need in the art for apparatus and methods for lay-up tools that provides a substantial weight reduction from all-Invar tools and substantial durability over all-composite tools. There is a further need in the art for apparatus and methods for lay-up tools comprising a hybrid combination of Invar and composite construction.

### BRIEF SUMMARY OF THE INVENTION

The present invention, in one embodiment, is a lay-up tool comprising a metallic working surface and a composite back structure. The lay-up tool may have an Invar working surface. The working surface and the back structure may be coupled using a self-locking connection mechanism.

The present invention, in another embodiment, is a method for providing a hybrid lay-up tool. The method may include providing a metallic face sheet, providing a composite back structure, and operably coupling the metallic face sheet with the composite back structure using a self-locking connection mechanism.

The present invention, in yet another embodiment, is a lay-up tool comprising an Invar working surface and a carbon fiber composite back structure, the back structure having more than one interlockable component. The Invar working surface and the carbon fiber composite back structure may be adapted to be operably coupled to one another in a fixed position.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is isometric view of a hybrid production tool in accordance with one embodiment of the present invention.

FIG. 2 is fragmentary, isometric view, prior to connection, of first and second members of a precision self-locking connection mechanism that may be used to connect a face sheet with a back structure to form a hybrid tool in accordance with another embodiment of the present invention.

### DETAILED DESCRIPTION

The present disclosure includes novel and advantageous apparatus and methods for lay-up tools. More particularly, the present disclosure relates to apparatus and methods for lay-up tools comprising a hybrid combination of Invar and composite construction. A hybrid combination of Invar and composite construction may provide a tool with reduced weight and the durability of a metallic working surface. The present disclosure further relates to apparatus and methods for connecting the Invar components with composite components. A hybrid lay-up tool may utilize a thin, metallic working surface, i.e., face sheet, in combination with a composite back structure. The back structure may support the face sheet and maintain a required geometry necessary for molding the part. The face sheet and the back structure may be joined together using a joint structure, such as the precision self-locking connection mechanism and method described in copending U.S. patent application Ser. No. 11/094,331, filed Mar. 30, 2005, published as US 2005/0247756, entitled “Connection Mechanism and Method,” the entirety of which is hereby incorporated by reference herein.

The apparatus and methods of the present disclosure provide weight advantages, particularly weight reduction, over tools produced solely from Invar and further provide improved durability, longer life, and reduced cost over tools produced solely from composite. An additional advantage of a lay-up tool in accordance with the present disclosure is that tool manufacturers, particularly those with large five-axis equipment, are willing to machine Invar but not composite. That is, the normal supply chain of Invar is not existent for composite. As such, a lay-up tool in accordance with the present disclosure allows the use of traditional suppliers.

The applications of a hybrid lay-up tool include laying up advanced composite parts. Applications of a hybrid lay-up tools may be exemplified in the aerospace industry, for example. However, a hybrid lay-up tool of the present disclosure may be used in any suitable industry.

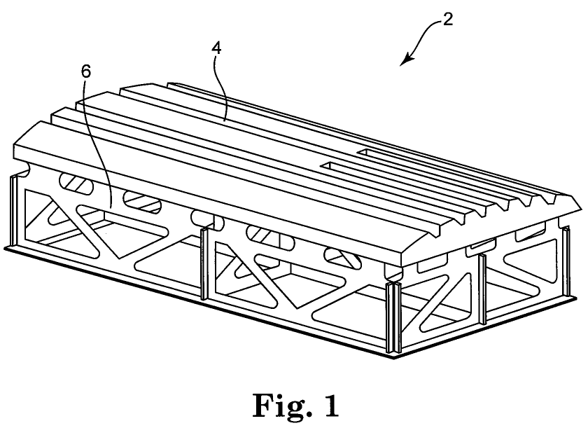

As previously described, a hybrid lay-up tool 2, as illustrated in FIG. 1, may utilize a thin, metallic working surface, or face sheet 4. In one embodiment, the face sheet 4 may be manufactured from Invar, a nickel-iron alloy. Invar provides durability to the working surface. The Invar surface, or face sheet 4, may be a molding surface for laying up composite, such as but not limited to carbon fiber composite. The Invar face sheet 4 may be machined and/or configured to a particular dimension, shape, and molding depending on the composite part desired to be laid up on the hybrid lay-up tool 2. In further embodiments, the Invar face sheet 4 may be thinly machined to further decrease weight. The Invar face sheet 4 may be obtained through traditional suppliers of machined Invar.

A composite back structure 6 may provide the base for the face sheet 4. In one embodiment, the composite back structure 6 may be manufactured from carbon fiber. A back structure 6 manufactured from carbon fiber may generally provide a back structure that has a coefficient of thermal expansion that is generally near the coefficient of thermal expansion for Invar. Therefore, any distortions between the face sheet 4 and the back structure 6 during lay up may be minimal or eliminated.

A composite back structure 6 may provide a lightweight base for the face sheet 4. As compared to an all-Invar tool, therefore, a hybrid tool 2 comprising an Invar face sheet 4 and composite back structure 6 may provide a significant weight reduction. In some embodiments, a hybrid tool 2 in accordance with the present disclosure may provide a weight reduction over an all-Invar tool of up to 10%, up to 25%, up to 50%, or any other suitable amount of weight reduction depending on the specifications of the tool. A composite back structure 6 may further provide rigidity since its modulus (E) may be higher. Thus, the composite back structure 6 may provide reduced weight and increased stiffness for maintaining tool geometry.

A composite back structure 6, in a further embodiment, may be manufactured as separate pieces. The separate pieces may be joined together, for example, by interlocking the separate pieces, to form the desired geometry for the back structure 6. Any suitable joint may be used for interlocking the separate pieces, including any combination of two or more joints. The interlocked pieces may be bonded together. As used herein, bonded may include any connection joined via glue, epoxies, adhesives, cements, and the like. In some embodiments, the joined pieces may be reinforced, for example, to increase the strength of the joints. In other embodiments, the separate pieces may be joined together by any suitable means for joining two composite pieces. In yet a further embodiment, the separate pieces may be joined together in a conventional “egg crate” structure.

The Invar face sheet 4 may be operably coupled to the composite back structure 6. The Invar face sheet 4 may be coupled to the back structure 6 using any means suitable for joining the Invar face sheet 4 to the back structure 6, such as any joints known in the art. For example, the Invar face sheet 4, in one embodiment, may be coupled to the composite back structure 6 using a bonded dado joint, or the like. In another embodiment, portions of the composite back structure 6 may be thinned, or narrowed, and the Invar face sheet 4 may include receiving joints for receiving the thinned, or narrowed, portions of the composite back structure 6. In some embodiments, the Invar face sheet 4 may be permanently attached to the composite back structure 6.

In a further embodiment, the Invar face sheet 4 may be operably coupled to the composite back structure 6 using a precision self-locking connection mechanism and method, such as that described in copending U.S. patent application Ser. No. 11/094,331.

Generally, the connection mechanism described in U.S. patent application Ser. No. 11/094,331 may comprise two members. One of the members may include a connection rib extending outwardly from a mating surface. The other member may include a corresponding connection groove on a mating surface to receive the connection rib of the first member in a connecting relationship. A backing member or other means may further be provided to assist in retaining the rib within the groove. The connection mechanism, and its use in combination with the hybrid lay-up tool of the present disclosure, is described with further detail below.

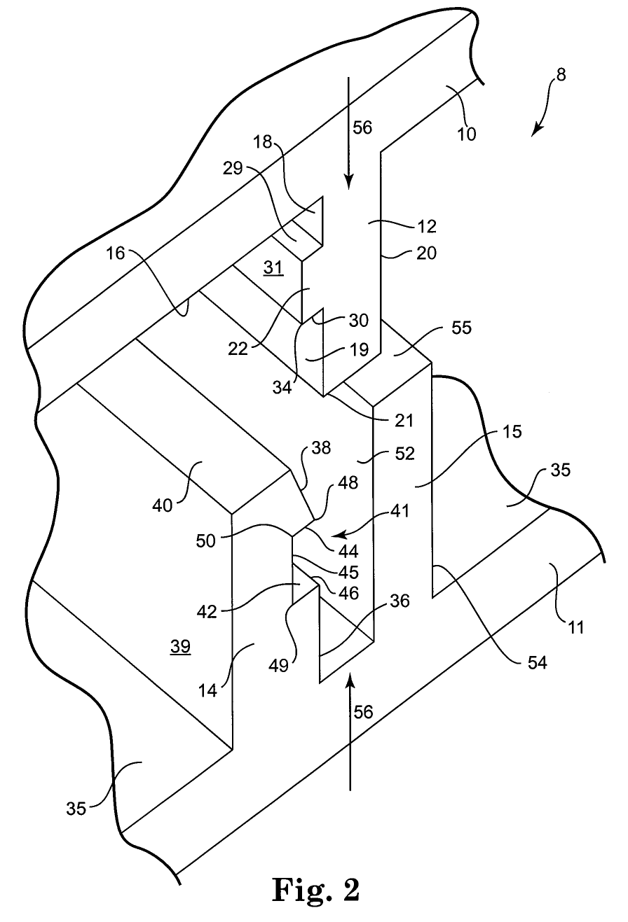

The connection mechanism 8, as illustrated in one embodiment in FIG. 2, may include a first connection member 12 integrally formed with a first member 10, a mating or second connection member 14 integrally formed with a second member 11, and a backing member 15 spaced from the second connection member 14. The backing member 15 may function primarily to maintain the first and second connection members 12 and 14 in proper connection relationship. In accordance with one embodiment of the present disclosure, the first member 10 may be the face sheet 4, while the second member 11 may be the back structure 6. In another embodiment, the first member 10 may be the back structure 6, while the second member 11 may be the face sheet 4. In further embodiments, any combination of first 10 and second 11 members, either on the face sheet 4 or the back structure 6, may be used for a single hybrid tool 2. Similarly, any suitable number of connecting mechanisms 8 may be used to operably couple the face sheet 4 to the back structure 6.

The first member 10 may include a base or main portion, which may be defined, in part, by a proximal surface 16. The proximal surface 16 may be the surface of the first member 10 from which the first connection member 12 extends. As shown, the first connection member 12 may extend outwardly from the proximal surface 16 and may include a first, or connection, side surface formed of the surface portions 18 and 19, an opposite second side surface 20, and a distal end surface 21. A connection rib 22 may extend outwardly from the connection surface of the connection member 12 between the surface portions 18 and 19.

The second or opposite surface 20 of the connection member 12 may, in the embodiment illustrated in FIG. 2, be parallel to the surface portions 18 and 19 and extend outwardly from the proximal surface 16 at approximately a right angle. The distal surface 21 of the connection member 12 may be parallel to the proximal surface 16 and thus join with the surface 20 and the surface portion 19 at approximately right angles.

The second member 11 may also include a base or main portion defined, in part, by a proximal surface 35 and a second connection member 14 extending outwardly from the proximal surface 35. The second connection member 14 may include a first or connection surface defined by the surface portions 36 and 38, a second or opposite surface 39, and a distal surface 40. The portion 38 of the connection surface may be a beveled, lead-in surface. As illustrated, a connection groove 41 may be formed within the connection surface between the surface portions 36 and 38. The groove 41 may include a proximal groove surface 42, which joins with and extends inwardly from the surface portion 36 along the proximal groove shoulder 46. The groove 41 may also include a distal surface 44, which joins with and extends inwardly from the surface portion 38 along the distal groove shoulder 48. The groove 41 may also include an inner surface 45 joining with the groove surfaces 42 and 44 along the groove edges 49 and 50, respectively.

The backing member 15, in an embodiment of the connection mechanism illustrated in FIG. 2, may be a generally rectangular rib-type structure extending outwardly at substantially right angles from the proximal surface 35 of the member 11. The backing member 15 may include a first surface 52 facing the surface portions 36 and 38 and a second or opposite surface 54. A distal surface 55 may extend between and be joined with the surfaces 52 and 54 at their distal edges. In accordance with the present disclosure, the backing member 15 may function to define and maintain the first connection member 12 and the second connection member 14 in proper connecting relationship, so that the rib 22 may interlock with, and be retained within, the groove 41.

To connect the first connection member 12 to the second connection member 14, and thus the first member 10 to the second member 11, e.g., the face sheet 4 to the back structure 6, the members 10 and 11 may be moved toward one another in the direction of arrows 56. During this movement, the distal end of the first connection member 12 may enter the area between the second connection member 14 and the backing member 15. As this movement continues, the surface 20 of the connection member 12 may begin to engage and slide along the surface 52 of the backing member 15. As the members 10 and 11 continue to move toward one another, a distal shoulder 34 of the rib 22 may engage the beveled, lead-in surface 38 of the connection member 14. Continued movement of the members 10 and 11 toward one another may cause the second connection member 14 to flex outwardly to allow the connection rib 22 to move past the shoulder 48. When the rib 22 completely passes the shoulder 48, the second connection member 14 may snap back into its original, unflexed position with the connection rib 22 seated within and received by the connection groove 41. In this connected position, the distal surface 21 of the first connection member 12 may be substantially engaged with the proximal surface 35 of the member 11, and the distal surface 40 of the second connection member 14 may be substantially engaged with the proximal surface 16 of the member 10. Further, the rib 22 may be seated within the groove 41, so that rib surfaces 29 and 30 are substantially engaged with the groove surfaces 44 and 42, and the rib surface 31 is substantially engaged with the groove surface 45.

To enable the first and second connection members 12 and 14 to lock into connecting engagement with one another, at least one or more of the first and second connection members 12 and 14 and the backing member 15 may be sufficiently flexible to allow the connection rib 22 to move past the shoulder 48 of the connection member 14 and thus permit the rib 22 to seat within the groove 41. In addition to being sufficiently flexible to allow the connection members 12 and 14 to move into connecting engagement as described above, the flexible member or members must also have the ability to return to its normal, unstressed position after the connection members 12 and 14 have been moved into connecting relationship with the rib 22 inserted within the groove 41. In accordance with the present disclosure, at least one or more of the connection members 12 and 14 and the backing member 15 may be provided with such flexibility.

In further embodiments, the connection mechanism 8 may be used in combination with a further connection technique, such as friction stir welding, conventional welding, brazing, and bonding. As used herein, bonding may include any connection via glue, epoxies, adhesives, cements, and the like. The use of a second connection technique with the connection mechanism may provide strength and durability to the connection joint.

Although one embodiment of a precision self-locking connection mechanism and method has been generally described herein, further detail is provided and various alternative embodiments of a precision self-locking connection mechanism and method are described in U.S. patent application Ser. No. 11/094,331. The embodiment illustrated in FIG. 2 is exemplary, and each of the various embodiments disclosed in U.S. patent application Ser. No. 11/094,331 may be adapted and used in combination with the hybrid lay-up tool 2 of the present disclosure.

In operation, a hybrid lay-up tool 2 in accordance with the present disclosure may be used in well known procedures for manufacturing advanced composite parts. Generally, in one embodiment, a resin-impregnated fabric, such as a resin-impregnated carbon cloth may be placed, or laid up, on the working surface of the Invar face sheet 4. A vacuum bag may be placed over the finished lay up. The hybrid tool 2 may then be placed in an autoclave, and a vacuum may be drawn in the vacuum bag. A pressure may be applied outside of the vacuum bag, for example a pressure of approximately 80-100 PSI, and the autoclave may be heated, for example to a temperature of generally above 200° F., a temperature generally above 300° F., or any other suitable temperature for curing the laid up resin-impregnated fabric. An Invar face sheet, as opposed to an composite face sheet, provides greater durability during such a process. A composite face sheet may be damaged much easier than an Invar face sheet and provides an increased potential for leaks. Leaks during the manufacture of such parts may result in unusable parts. In some processes, leaks can lead to very expensive waste if the parts are unusable.

Although the present invention has been described with reference to preferred embodiments, persons skilled in the art will recognize that changes may be made in form and detail without departing from the spirit and scope of the invention.

We claim:

1. A lay-up tool comprising a metallic working surface and a composite back structure.

2. The lay-up tool of claim 1, wherein the metallic working surface is an Invar working surface.

3. The lay-up tool of claim 2, wherein the composite back structure comprises more than one piece, the pieces being interlockable with one another to from the back structure.

4. The lay-up tool of claim 3, wherein the working surface is adapted to be operably coupled to the back structure.

5. The lay-up tool of claim 4, wherein the working surface is adapted to be removably coupled to the back structure.

6. The lay-up tool of claim 4, wherein the working surface is operably coupled to the back structure using at least one bonded dado joint.

7. The lay-up tool of claim 4, wherein the working surface is operably coupled to the back structure using at least one self-locking connection mechanism, the at least one self-locking connection comprising:
a first connection member extending outwardly from a first surface, the first connection member having a connection surface and a connection rib extending outwardly therefrom;
a second connection member extending outwardly from a second surface, the second connection member having a connection surface generally parallel to the connection surface of the first connection member and a connection groove formed therein to receive the connection rib;
a backing member extending outwardly from one of the first or second surfaces to retain the first and second connection members in connecting engagement with the connection rib received within the connection groove; and
at least one of the first and second connection members and the backing member being sufficiently flexible to permit the connection rib to be inserted into and received by the connection groove.

8. The lay-up tool of claim 7, wherein the one of the working surface and back structure comprises the first surface.

9. The lay-up tool of claim 8, wherein the other of the working surface and the back structure comprises the second surface.

10. The lay-up tool of claim 4, wherein the working surface is operably coupled to the back structure using a self-locking connection mechanism in combination with a further connection mechanism comprising one or more of friction stir welding, brazing, conventional welding, and bonding.

11. A method for providing a hybrid lay-up tool comprising:
providing a metallic face sheet;
providing a composite back structure; and
operably coupling the metallic face sheet with the composite back structure using a self-locking connection mechanism.

12. The method of claim 11, wherein the metallic face sheet is an Invar face sheet.

13. The method of claim 12, wherein the self-locking connection mechanism comprises:
a first connection member; and
a second connection member;
wherein one of the first and second connection members includes a connection rib and the other of the first and second connection members includes a connection groove to receive the connection rib.

14. The method of claim 11, further comprising applying a further connection mechanism between the working surface and the back structure comprising one or more of friction stir welding, brazing, conventional welding, and bonding.

15. A lay-up tool comprising an Invar working surface and a carbon fiber composite back structure, the back structure comprising more than one interlockable component, wherein the Invar working surface and the carbon fiber composite back structure are adapted to be operably coupled to one another in a fixed position.
